(19) United States
(12) Patent Application Publication
(10) Pub. No.: US 2016/0112624 A1
(43) Pub. Date: Apr. 21, 2016

(54) Camera System for Vehicles

(71) Applicant: CONTI TEMIC MICROELECTRONIC GMBH, Nürnberg (DE)

(72) Inventors: Dieter KROEKEL, Eriskirch (DE); Gerhard MUELLER, Bad Waldsee (DE); Eva MIEL, Wangen (DE); Andreas GRUBER, Lindenberg i. Allg. (DE); Juergen HABICHER, Hohenweiler (AT); Wolfgang FEY, Bodolz (DE)

(21) Appl. No.: 14/893,633

(22) PCT Filed: Mar. 7, 2014
(86) PCT No.: PCT/DE2014/200115

§ 371 Date: Nov. 24, 2015

(30) Foreign Application Priority Data
May 28, 2013 (DE) 10 2013 209 940.1

(51) Int. Cl. H04N 5/232; B60R 1/00; B60R 11/04; H04N 7/18; H04N 21/414

(52) U.S. Cl. CPC H04N 5/23206; H04N 7/181; H04N 21/41422; B60R 11/04; B60R 1/00; B60R 2300/105; B60R 2300/50

(57) ABSTRACT

The invention relates to a camera system (10) for vehicles that includes multiple cameras (12, 14, 16, 18) which are interconnected via a network (20, 22, 24, 26) with a ring topology, wherein each camera is configured to perform image processing of captured images and wherein each camera is further configured to transmit captured images and/or image processing results to other cameras in the network for image processing by these cameras or for supporting the image processing performed by these cameras, such that the computing load of image processing in the network is distributed among multiple cameras or the computing load of image processing performed by cameras in the network is reduced.

This invention relates to a camera system for vehicles.

Camera systems such as so-called top view or surround view systems are increasingly found in vehicles to display the immediate surroundings of the vehicle to the driver and make it easier for the driver to maneuver his or her vehicle, for example. It is envisaged that future systems will increasingly be equipped with automatic driver assistance functionalities. This requires image processing to automatically detect objects, especially obstacles, and to permit subsequent intervention in the vehicle dynamics, for example automatic braking when an obstacle is detected while parking a vehicle.

Previous system architectures provide a star topology with a central control unit to which all system cameras transmit image data. However, the control unit must have sufficient computing power for processing the image data, which can mean considerable processing power requirements, especially for large image data volumes. DE 10 2010 030 068 A1 therefore proposes to transcode the image data captured by cameras used in a vehicle and then transmit the transcoded image data via a wireless interface to a back end for image processing, such that the computing power required for image processing does not have to be provided by the vehicle and the vehicle does not need to have complex and expensive special components.

In addition to computing power requirements for image processing, such systems may also have to meet functional system safety requirements. If such camera-based systems are to automatically intervene in the vehicle dynamics, functional system safety requirements are clearly higher than for just indicating systems.

It is therefore the object of this invention to propose a camera system for vehicles that is technically simpler and cheaper to create than previous architectures with a central control unit, especially when it comes to the computing power required for efficient image processing and to functional safety.

This object is achieved by the subject matter of the independent claims. The dependent claims disclose other embodiments of the invention.

One underlying idea of the invention is to provide a camera system with a ring topology that is equipped with cameras which can each perform independent image processing not only of their own captured images but of images captured by other cameras as well. In this way the computing load of image processing can be distributed among several components, i.e. cameras, of the system and/or reduced, and there is no need to provide a central control unit with sufficient computing power in the vehicle. The ring topology of the camera system according to the invention has the following additional advantages compared to a system with a central evaluation unit:
Increase in fault tolerance: In the event that one of the connections between two adjacent cameras in the ring topology fails, all cameras can typically still communicate with one another if the ring topology is designed accordingly.
Distributed computing: In applications which do not read the images of all cameras (e.g. backup aid, blind spot detection), the image or partial tasks of image analysis or control can be passed on/handed over to the camera(s) that is/are not involved to distribute the computing load evenly and make it more efficient.
In a system with a central ECU and cameras connected via Ethernet, the video transmission must be compressed (e.g. Mjpeg, H264) due to the bandwidth limitation (e.g. 100 Mbps). Compression is not loss-free, and as a result essential information is lost, especially in high motion scenes. This loss of information can be avoided in the ring topology system because each camera system can perform its own image processing in the ring topology. On the other hand, high compression is acceptable for the displayed image because the loss of information in the image is barely visible to a viewer.

One embodiment of the invention relates to a camera system for vehicles that includes multiple cameras which are interconnected via a network with a ring topology, wherein each camera is configured to perform image processing of captured images and wherein each camera is further configured to transmit captured images and/or image processing results to other cameras in the network for image processing by these cameras or for supporting the image processing performed by these cameras, such that the computing load of image processing in the network is distributed among multiple cameras or the computing load of image processing performed by cameras in the network is reduced. The ring topology and the addition of image processing capability to the cameras result in a camera system with the option of distributed image processing or distributed computing or reduction of the computing load of image processing performed by individual cameras in the system, which is more fault tolerant and partially more efficient than a camera system with a central image processing unit or even outsourced image processing as known from the system disclosed in DE 10 2010 030 068 A1. The image processing results to be transmitted from one camera to other cameras in the network can for example be object lists that can be used for accelerated or simpler object detection by the image processing function of the receiving camera.

Each camera can further be configured to transmit captured images to another camera in the network only after it has completed its own image processing, such that at any point in time only one camera in the network performs image processing in the network. This not just permits image distribution to be distributed among multiple cameras but also time-division multiplexing, to save energy at the cost of processing time, for example. For this purpose, only one camera of the system performs image processing at a given point in time. When the processing is completed, the system switches to the next camera and so on until the entire image processing is completed. If four cameras are used, power can be saved by a factor of about 4 while the time needed for image processing extends by approximately the same factor.

The time needed to capture an image and the time needed to process an image by this camera can be such that they are shorter than a cycle predetermined in the camera system. Given sufficient computing power, the image capture time and image processing time of a camera can for example be so short that sequential processing of all captured images can be performed within the predetermined cycle. This facilitates particularly fast image processing in the system.

The network connections between two adjacent cameras in the ring topology can be bidirectional, and each camera can have access to the images captured by its adjacent cameras in the network in addition to its own captured images for image processing. In a system with four cameras, for example, cameras 1 and 3 can receive images from adjacent cameras 4 and 2 while processing or capturing images, and the cameras 4 and 2 can receive images from cameras 1 and 3 while capturing images. The transmission direction in the network is thus reversed with each frame, i.e. each capture of a new image. Each camera can process or calculate images for a period of two frames. This ensures that each camera has access to multiple images for image processing, which makes distributed image processing in the system more efficient. A so-called genuine double frame concept can be implemented as well: For example, the cameras can always capture two subsequent images or frames A and B. The cameras 1 and 3 can then process image or frame A and transmit the image or frame B to cameras 2 and 4 for image processing. Cameras 2 and 4 can process the image B received and only pass image or frame A on for image processing to cameras 1 and 3.

Each camera can also be configured to perform image processing of a captured image within the time it takes to capture two subsequent images. This permits particularly fast image processing by the camera system, which can in particular be important in case of almost real time requirements to be met by the camera system and its image processing function.

Finally, each camera can also be configured to either transmit a captured image to at least one adjacent camera in the network simultaneously with capturing the image or to transmit a captured image after capturing to at least one adjacent camera in the network while capturing a subsequent image. In this way, a double frame concept can be implemented in the camera system in which a camera can also use the images of adjacent cameras in the ring topology, for example for more efficient image processing and more accurate object detection.

The cameras can monitor one another to increase the fault tolerance of the camera system. This plays an increasingly significant role in safety-relevant applications, such as the detection of persons to prevent accidents during maneuvering. This means each camera can further be configured to monitor one or several other cameras in the network for failures.

One or several cameras can be connected for communication to a vehicle bus and/or at least one camera can be connected to a display unit of a vehicle via a video output that can output images and/or image processing results. If two or more cameras are connected to the vehicle bus, fault tolerance compared to a system having just one camera connected to the vehicle bus can be increased. A video output makes it possible to directly display images captured and optionally processed, which can provide immediate feedback to a driver when parking or maneuvering his or her vehicle.

Another embodiment of the invention relates to a camera for use in a camera system according to the invention and as described herein, having an image sensor for capturing images, an image processing unit for performing image calculations with captured images, and a network interface unit for a network with a ring topology and for receiving images and/or commands and/or image processing results from adjacent cameras in the network with a ring topology and for transmitting captured images and/or commands and/or image processing results to adjacent cameras in the network with a ring topology.

The camera can further include an image data encoding unit for encoding captured and/or processed images to transmit them to adjacent cameras in the network with a ring topology. By encoding, images can for example be converted into a particularly suitable format for transmission via network connections between the cameras.

The present invention is particularly suited for use with a driver assistance system that can autonomously intervene in the vehicle dynamics.

Other advantages and applications of this invention will be explained in the description below with reference to the embodiment(s) shown in the drawing(s).

The terms and associated reference symbols listed in the List of Reference Symbols below are used in the description, the claims, the abstract, and the drawing(s).

Wherein

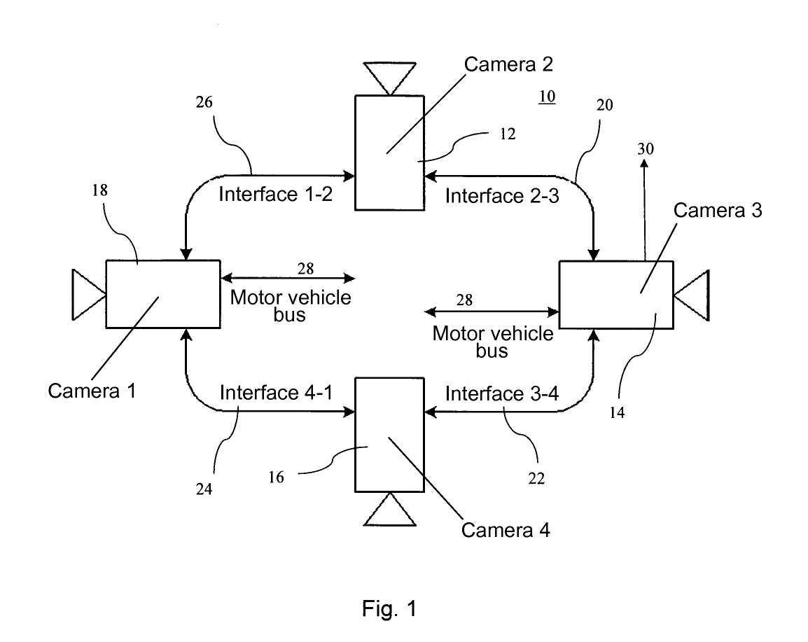

FIG. 1 is a schematic view of an exemplary embodiment of a camera system for vehicles with four cameras according to the invention;

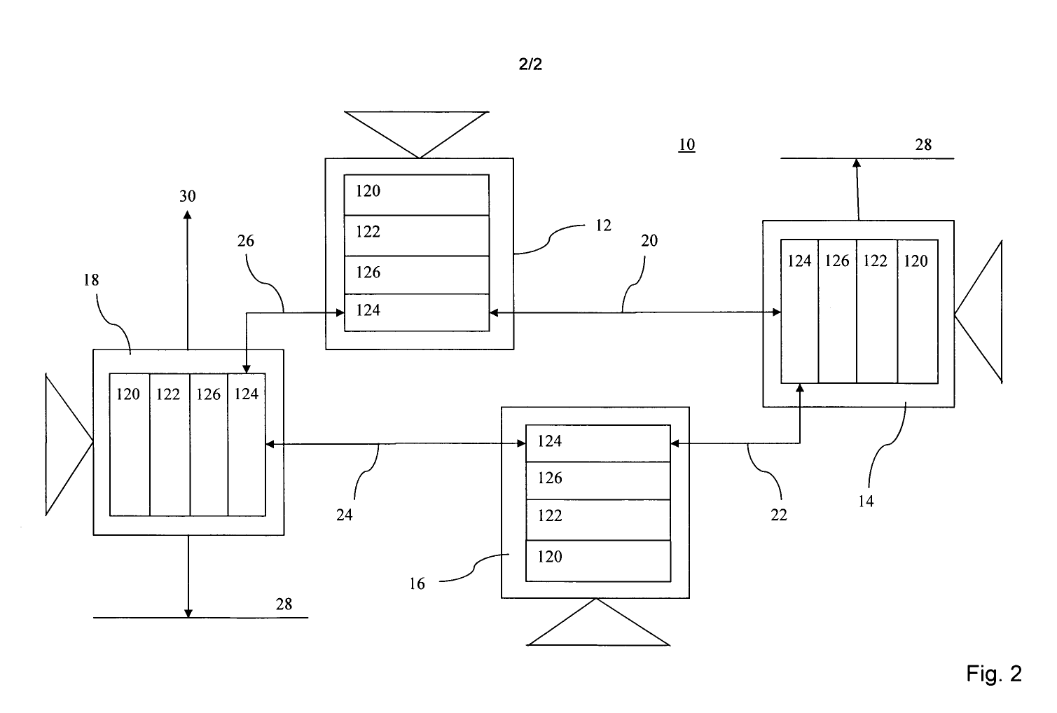

FIG. 2 shows the camera system from FIG. 1 in detail.

Identical, functionally identical, and functionally connected elements can be assigned the same reference symbols in the description below. Absolute values are only given as examples below and not to be understood as restricting the invention.

FIG. 1 shows a camera system 10 including four cameras 12, 14, 16, and 18, which are interconnected in a ring topology. For this purpose each of the cameras is connected for communication with its two adjacent cameras in the ring topology, that is, the camera 12 is connected via a network connection 20 to the camera 14, which is connected via a network connection 22 with the camera 16. The camera 16 is itself connected with the camera 18 via a network connection 24. The ring is closed by the network connection 26 between cameras 18 and 12. The network connections 20, 22, 24, and 26 can be unidirectional or bidirectional. A bidirectional network connection has certain advantages, which will be explained below.

The cameras 18 and 14 are also connected for communication to the vehicle bus (motor vehicle bus) 28 via which they can be included, for example, in a driver assistance system and exchange data with a control computer of the assistance system. The cameras 12, 14, 16, and 18 can for example be part of a top view or surround view system and oriented such that they can capture the entire surroundings of a vehicle.

Each camera 12, 14, 16, and 18 includes its own image processing unit which can process the images captured by the camera as well as images captured by other cameras. The image processing performed by the unit is preferably adapted to the task of the camera system; for example, it can be configured to detect objects in the surroundings of the vehicle and to transmit lists of detected objects, so-called object lists, via the vehicle bus 28 to a driver assistance system with active driving dynamics intervention. The cameras 12, 14, 16, and 18 are further configured to outsource image processing tasks to other cameras of the system or to transmit image processing results such as object lists to other cameras of the system to be able to efficiently distribute the computing load caused by image processing within the camera system or to reduce the computing load of image processing performed by cameras in the network.

The ring topology of the camera system 10 can increase fault tolerance. If the network connections 20, 22, 24, and 26 in the system 10 are bidirectional—as shown in FIG. 1—the communication of the remaining cameras in the system can be maintained even if one camera in the system fails. If for example camera 12 fails, the cameras 14, 16, and 18 can still communicate via the network connections 22 and 24. If two cameras 14 and 18 are connected to the vehicle bus 28, as in FIG. 1, communication via the vehicle bus 28 can be ensured even if one of these two cameras 14 or 18 fails.

FIG. 2 shows the design of the cameras 12, 14, 16, and 18 of the system 10 in detail: Each of the cameras 12, 14, 16, 18 comprises an image sensor 120 (imager) for capturing images and generating digital image data of the captured images, an image processing unit 122 for processing the digital image data generated by the image sensor 120 in accordance with a specific algorithm (e.g. for object detection or monitoring and analysis of the surroundings), optionally an image data encoding unit 126 for converting the digital image data of captured or processed images into another format, and a network interface unit 124 for communication with other cameras of the system 10. All cameras are designed almost identically with respect to hardware. The cameras 14 and 18 also include an interface for coupling to the vehicle bus 28. In addition, the camera 18 has an (optional) video data output 30 via which it can be connected to a display system. In principle, all cameras can be completely identical in design, in particular, all cameras can include a vehicle bus interface and a video data output. For the design, specially developed ASICs (application specific integrated circuits) can be used, especially for image preprocessing, since such development is worthwhile due to the large number of units needed.

As mentioned above, the camera system 10 can output images. For this purpose, the camera 18 which is located closest to a display in the vehicle can pass on the images captured with the system 10 (camera images) to the display. This permits a more efficient cabling in the vehicle. If the ring bus formed by the network connections 20, 22, 24, and 26 is Ethernet-based, today's bandwidth limitations for a transmission in the vehicle are typically around 100 Mbps. Since the images for display allow high compression rates, they can be transported on the ring bus even if there are such bandwidth limitations and then be output via the video data output 30 from camera 18, which is located closest to the display in the vehicle (e.g. the front camera).

The design of the cameras 12, 14, 16, and 18 and the ring bus permit distributed image processing of the camera system 10—as mentioned above (also called distributed computing herein, since digital image processing involves complex computing operations). In this respect, two aspects should be noted: Distributed computing can be locally distributed, i.e. different computing operations within image processing can be distributed among multiple cameras in the system; but distribution can also be over time (time-division multiplexing), e.g. to save power during image processing (at the cost of processing time). This can take place in such a manner that only one camera is active at a specific point in time and performs image processing or calculation, and then the system switches to the next camera, and so on. This could save power by a factor of about 4 for a system with 4 cameras. When the image processing units implemented in the cameras have sufficient computing power, it would also be possible to design the calculation cycle including image import shorter than one system cycle, and sequential calculation of all camera images in one system cycle would be conceivable as well.

The camera system 10 can operate with a predetermined cycle time or cycle in accordance with a clock rate, i.e. all operations performed in the system 10 are performed in accordance with the predetermined cycle, which gives predetermined cycle times to the cameras 12, 14, 16, and 18, which correspond to clock cycles in clocked systems. The cycle can be such that specific operations of the cameras, such as taking or capturing an image or a specific computing operation within the image processing performed by the cameras, take place or are performed within one cycle. The cycle can thus be viewed as a set internal clock. One camera of the system can set the cycle via the ring bus, or alternatively via the vehicle bus, or the cycle can be provided by respective clocks in each of the cameras.

The following is a description of an embodiment of the camera system according to the invention with a so-called double frame concept in which a camera also uses neighboring images from the adjacent cameras in the ring topology. If the transmission between the cameras is bidirectional and a suitable double frame concept (frame sequence A-B-A-B . . . ) is used, each camera can always have access to its own image and the images of the two adjacent cameras for image processing. The double frame concept is suitable for capturing, for example, images with different camera parameters such as exposure times, characteristic curves, resolutions, etc. For example, a camera can capture two subsequent images with different parameters such as a short and a long exposure time (frames A and B). The images captured with different parameters can then be used for different applications, e.g. lane detection (images with a long exposure time, frame A) and traffic sign recognition (image with a short exposure time, frame B). Depending on the application, the images or frames captured with different camera parameters can then be distributed to different cameras in the system for optimum computing load distribution.

An example of the double frame concept is illustrated below. Frame A: The cameras 1 and 3 (FIGS. 1) or 18 and 14 (FIG. 2) take an image and simultaneously receive the images taken by the cameras 4 and 2 (FIGS. 1) or 16 and 12 (FIG. 2). Frame B: The cameras 2 and 4 (FIGS. 1) or 12 and 16 (FIG. 2) take an image and simultaneously receive the images taken by the cameras 1 and 3 (FIG. 1) or 18 and 14 (FIG. 2). Thus the direction of image transmission between the cameras is reversed with each frame. Each camera can calculate or process images for a period of 2 frames. A genuine double frame concept in which both cameras always capture frames A and B is also conceivable. But the cameras 1 and 3 (18, 14) will for example just calculate on image A and only pass on image B. The cameras 2 and 4 (12, 16) only calculate on image B and will pass on image A.

According to another embodiment of the camera system of the invention, images can also be taken with a time offset. Various manifestations are conceivable: For example, an image can be passed on simultaneously with the capture. An image can also be output after it has been taken, since it has to be cached anyway for internal processing. In this case, the image can be output while the receiving camera is taking an image.

Finally, an embodiment of the invention will be explained in which, alternatively or in addition to the transmission of captured images, image processing results are transmitted to adjacent cameras in the system in the form of object lists. For example, a front camera which captures a 180° range of detection in front of a vehicle and performs image processing for object detection, can transmit an object list of detected objects such as a lane and side areas with grass to an adjacent side camera, which can then perform the image processing of its own captured images more efficiently based on the object list received from the front camera to detect the grassy side strip, e.g. because it does not have to run a search in the captured images for a grassy side strip but can directly verify the grassy side strip in its own captured images based on the object list received. This can reduce the computing load of image processing.

The camera system according to the invention primarily has the following advantages: All cameras can be of a substantially identical hardware design. Image processing is performed as distributed computing in the system, such that the performance is distributed or the computing load of image processing performed by individual cameras is reduced. The camera system can in principle be implemented without a central control unit. One or several cameras can be connected to the vehicle bus and in this way be included in a driver assistance system.

### REFERENCE SYMBOLS

10 Camera system

12 First camera

120 Image sensor

122 Image processing unit

124 Network interface unit

126 Image data encoding unit

14 Second camera

16 Third camera

18 Fourth camera

20 Bidirectional network connection

22 Bidirectional network connection

24 Bidirectional network connection

26 Bidirectional network connection

28 Vehicle bus

30 Video data output

1. A camera system (10) for vehicles, including
multiple cameras (12, 14, 16, 18) which are interconnected via a network (20, 22, 24, 26) with a ring topology,
wherein each camera is configured to perform image processing of captured images, and
wherein each camera is further configured to transmit captured images and/or image processing results to other cameras in the network for image processing by these cameras or for supporting the image processing performed by these cameras, such that the computing load of image processing in the network is distributed among multiple cameras or the computing load of image processing performed by cameras in the network is reduced.

2. The camera system according to claim 1, characterized in that each camera is further configured to transmit captured images to another camera in the network only after it has completed its own image processing, such that at any point in time only one camera in the network performs image processing in the network.

3. The camera system according to claim 1, characterized in that the time needed to capture an image by a camera and the time needed to process an image by this camera are such that they are shorter than a cycle predetermined in the camera system.

4. The camera system according to claim 1, characterized in that the network connections between two adjacent cameras in the ring topology are bidirectional, and each camera has access to the images captured by its adjacent cameras in the network in addition to its own captured images for image processing.

5. The camera system according to claim 1, characterized in that each camera is configured to perform image processing of a captured image within the time it takes to capture two subsequent images.

6. The camera system according to claim 1, characterized in that each camera is further configured to either
transmit a captured image to at least one adjacent camera in the network simultaneously with capturing the image, or
to transmit a captured image after capturing to at least one adjacent camera in the network while capturing a subsequent image.

7. The camera system according to claim 1, characterized in that each camera is further configured to monitor one or several other cameras in the network for failures.

8. The camera system according to claim 1, characterized in that one or several cameras are connected for communication to a vehicle bus and/or at least one camera is connected to a display unit of a vehicle via a video output that can output images and/or image processing results.

9. A camera (12) for use in a camera system (10) according to claim 1, comprising:
an image sensor (120) configured and arranged to capture images,
an image processing unit (122) configured and arranged to perform image calculations with captured images, and
a network interface unit (124) for a network with a ring topology, which is configured and arranged to receive images and/or commands and/or image processing results from adjacent cameras in the network with a ring topology, and is configured and arranged to transmit captured images and/or commands and/or image processing results to adjacent cameras in the network with a ring topology.

10. The camera according to claim 9, further comprising an image data encoding unit (126) configured and arranged to encode captured and/or processed images to transmit resultant encoded images to adjacent cameras in the network with a ring topology.
